(19) United States
(12) Patent Application Publication
(10) Pub. No.: US 2025/0267183 A1
(43) Pub. Date: Aug. 21, 2025

(54) Peer-to-peer communication between web browsers having digital certificates

(71) Applicant: DigiCert, Inc., Lehi, UT (US)

(72) Inventor: Avesta Hojjati, Austin, TX (US)

(73) Assignee: DigiCert, Inc., Lehi, UT (US)

(21) Appl. No.: 18/444,569

(22) Filed: Feb. 16, 2024

(51) Int. Cl. H04L 67/06; G06F 3/0486; H04L 9/40; H04L 67/104

(52) U.S. Cl. CPC H04L 67/06; G06F 3/0486; H04L 63/0823; H04L 67/104

(57) ABSTRACT

Systems and methods are provided for enabling peer-to-peer communications using web browsers. A user device, according to one implementations, comprises a processor, a network interface, a network accessing agent, and a client certificate. For example, the client certificate is issued subsequent to validating an identity of a user of the user device. The network accessing agent enables the user device to access a network via the network interface. Also, the client certificate enables the network accessing agent to form a trusted peer-to-peer link with another network accessing agent of a remote user device having another client certificate validating an identity of another user of the remote user device. Furthermore, the trusted peer-to-peer link enables the network accessing agent to securely transfer data files directly to the other network accessing agent of the remote user device while bypassing third-party file-sharing platforms.

### FIELD OF THE DISCLOSURE

The present disclosure relates generally to computing networks and digital certificates, namely X.509 certificates. More particularly, the present disclosure relates to systems and methods for certifying browser users to enable peer-to-peer communications.

### BACKGROUND

In the current computer age, the web browser has become an important tool for allowing users to access the Internet as well as performing an ever-expanding number of different functions. From the browser, a user can make financial transactions, gather information, watch news, look at funny cat videos, etc. Over time, new technologies have been developed to improve the generic web browser to provide users with more and more capabilities. Not only can a user review their search history, bookmark their favorite web sites, print out a web page, and customize various settings, but they can also manage passwords, enable privacy and security policies, manage financial accounts, etc. Therefore, improvements to these ubiquitous web browsers can improve the lives of users in a myriad of ways. Also, as the computing world heads more and more to decentralized networking, there is a need to incorporate decentralized capabilities into these browsers as well.

### BRIEF SUMMARY

The present disclosure relates to systems and methods for linking browsers of user devices using digital certificates for verifying the identity of the users of the respective user devices. This linking procedure enables decentralized peer-to-peer communications. In some embodiments, a process may be performed by a processing system in association with a web browser, network accessing agent, or the like, which may be stored in a non-transitory computer-readable medium. The web browser module may include computer logic or code having instructions for enabling or causing the processing system to perform certain actions. The processes may be implemented as a) methods having specific steps, b) via a processing device in a computer or smart device configured to implement the specific steps, and/or c) via a non-transitory computer-readable medium storing instructions for programming one or more processors to execute the specific steps.

A process, according to one implementation, includes a step of storing a client certificate, where the client certificate is issued subsequent to validating an identity of a user of the user device. The process further includes a step of enabling access to a network via a network interface of the user device. The client certificate enables the web browser module to form a trusted peer-to-peer link with a corresponding web browser module of a remote user device having a corresponding client certificate validating an identity of a remote user of the remote user device. Also, the trusted peer-to-peer link enables the web browser module to securely transfer data files directly to the corresponding web browser module of the remote user device while bypassing third-party file-sharing platforms.

In some embodiments, each of the network accessing agent and other network accessing agent may either be a web browser or a plug-in for extending the functionality of an existing web browser. In operation, the network accessing agent may be configured to securely transfer data files over the trusted peer-to-peer link according to instructions from the user. The step of securely transferring data files may include securely transmitting web address links, email messages, recorded videos, photos, video call requests, live video during a video call, contact information, and/or map directions. In particular, the transmission of contact information and map directions may be associated with a mobile device where the remote user may need this information.

Also, according to various implementations, the user device may include a certificate manager configured to store the client certificate, whereby the step of forming the trusted peer-to-peer link with the other network accessing agent of the remote user device may include a) sharing link codes associated with the user device with the remote user device, b) receiving other link codes associated with the remote user device from the remote user device, and c) storing the other link codes in the certificate manager. The certificate manager, for example, may be further configured to store link codes and user information associated with a plurality of remote user devices for enabling trusted peer-to-peer links with the plurality of remote user devices.

The network accessing agent, in some embodiments, may include a user interface allowing the user to select a peer-to-peer data sharing action, a private video call set-up action, and/or a peer-to-peer crypto transfer action. For example, regarding the peer-to-peer data sharing action, the user interface may also allow the user to conduct a drag and drop operation to initiate a procedure for transferring files from a file management system of the user device to a remote user device associated with a trusted user selected from a list of trusted users.

The user device, for example, may be a personal computer, a laptop computer, a tablet, or a smartphone. The client certificate and other client certificate are preferably issued by a trusted certificate authority. For instance, the client certificate and other client certificate may be X.509 digital certificates and/or confirm to other digital certification standards and protocols. Also, in some embodiments, the client certificate, which validates the identity of the user of the user device, may also be incorporated into one or more additional user devices to validate that the user is also an owner of the one or more additional user devices.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram illustrating a communications system, according to various implementations.

FIG. 2 is a block diagram illustrating the certificate authority shown in FIG. 1, according to various implementations.

FIG. 3 is a block diagram illustrating one of the user devices shown in FIG. 1, according to various implementations.

FIGS. 4A-4C are diagrams illustrating different file sharing strategies, according to various implementations.

FIGS. 5A and 5B are diagrams of a user interface showing a web browser, according to various implementations.

FIG. 6 is a diagram of a portion of a user interface showing a selected window allowing a user to perform a decentralized peer-to-peer file sharing action, according to various implementations.

FIG. 7 is a diagram of a portion of a user interface showing a selected window allowing a user to set up a decentralized peer-to-peer video call, according to various implementations.

FIG. 8 is a flow diagram illustrating an overall process for linking two browsers to enable decentralized peer-to-peer communications, according to various implementations.

FIG. 9 is a flow diagram illustrating a process for syncing browsers to enable decentralized peer-to-peer communications, according to various implementations.

### DETAILED DESCRIPTION

Again, the present disclosure relates to systems and methods for storing a client certificate that is issued to validate an identity of a user of a user device. The user can utilize the user device (with a web browser) to access a network (e.g., the Internet). Moreover, the client certificate enables the web browser to form a trusted peer-to-peer link with a corresponding web browser of a remote user device, where the remote user device also has a client certificate that validates an identity of a remote user of the remote user device. Also, the trusted peer-to-peer link enables the web browser to securely transfer data files directly to the corresponding web browser of the remote user device while bypassing third-party file-sharing platforms.

### Communications System

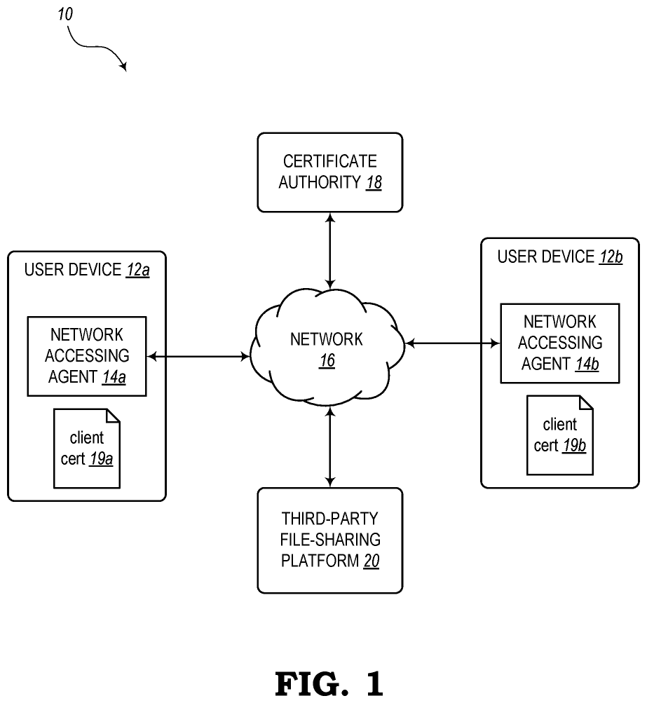

FIG. 1 is a block diagram illustrating an embodiment of a communications system 10 shown in a simplified form. In this embodiment, the communications system 10 includes a plurality of user devices (e.g., personal computers, laptop computers, tablets, mobile devices, etc.), although only two user devices 12a and 12b are shown for simplicity. The user devices 12a, 12b include network accessing agents 14a, 14b, respectively, which are configured to access a network 16 (e.g., the Internet) and/or communicate with other devices via the network 16. The network accessing agents 14a, 14b may also be referred to as browsers, web browsers, Internet browsers, user agents, terminals, etc. For example, the network accessing agents 14a, 14b may retrieve web page information from web servers (not shown) to browse the Internet or “surf the web.” In some embodiments, the network accessing agents 14a, 14b may be configured as plug-in for extending the utility of an existing browser on the respective user device 12a, 12b.

Also, the communications system 10 may further include a certificate authority 18 (e.g., DigiCert) or other suitable trusted entity that may be configured to issue certificates (e.g., digital certificates) to certify the authenticity or identity of users and/or user devices. According to the embodiments of the present disclosure, the certificate authority 18 is configured to issue client certificates 19a, 19b to the user devices 12a, 12b to authenticate the respective network accessing agent 14a, 14b. By certifying the network accessing agent 14a, 14b, the user devices 12a, 12b can securely communicate with each other with the confidence that the devices they are communicating with are legitimate. It should be noted that the certificate authority 18 may be configured to perform a number of other types of network security and certificate issuing services.

In addition, the communications system 10 includes a third-party file-sharing platform 20 or a plurality of file-sharing platforms, which may include known systems, such as OneDrive, Google Drive, etc. The third-party file-sharing platform 20 may include storage mechanisms (e.g., databases, data stores, etc.) for storing data “in the cloud” for customers. In some cases, the third-party file-sharing platform 20 may also allow a first user to send files from his or her device to another user associated with another user device, where this transfer of files involves passing the files (in a centralized manner) through the third-party file-sharing platform 20. It may be noted that the file transfer process may usually include the temporary or permanent storage of user data on the third-party file-sharing platform 20. However, according to the embodiments of the present disclosure, a certified network accessing agent 14 (with trusted client certificates 19a, 19b) is able to transfer files to another certified network accessing agent 14 in a decentralized manner in which the third-party file-sharing platform 20 is bypassed and files instead can be transferred directly.

### Computing Systems

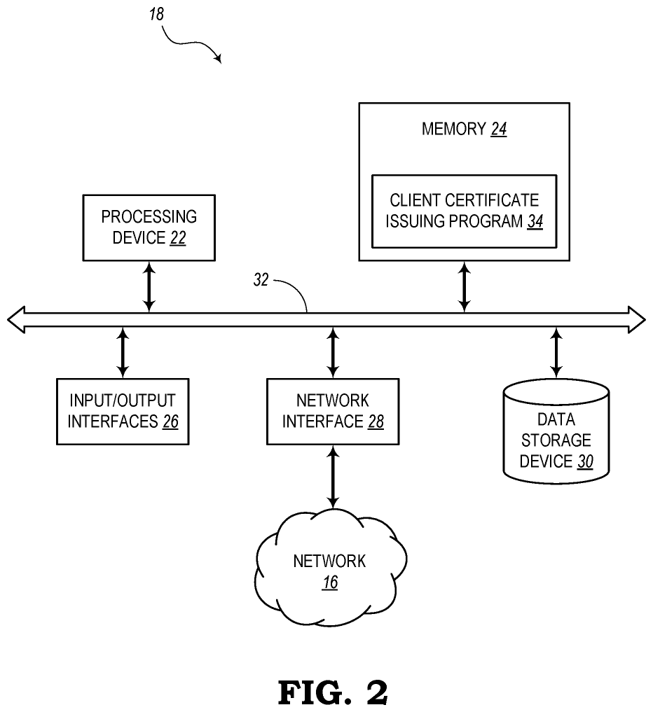

FIG. 2 is a block diagram illustrating an embodiment of the certificate authority 18 shown in FIG. 1. In this embodiment, the certificate authority 18 is shown in simplified form and is implemented as a computing system (or processing system) having a processing device 22, memory 24, input/output (I/O) interfaces 26, a network interface 28, and a data storage device 30, each interconnected via a local interface 32 (or bus) to enable communication therebetween. The network interface 28 enables the certificate authority 18 to communicate with other devices of the communications system 10 via the network 16. Furthermore, the certificate authority 18 includes a client certificate issuing program 34, which may be implemented in software or firmware in a non-transitory computer-readable medium (e.g., the memory 24). For example, the client certificate issuing program 34 may be configured, as described in more detail below, to issue client certificates to user devices 12 to certify the authenticity of the user devices 12 (or users thereof) to enable secure peer-to-peer communication between respective browsers (or network accessing agents 14).

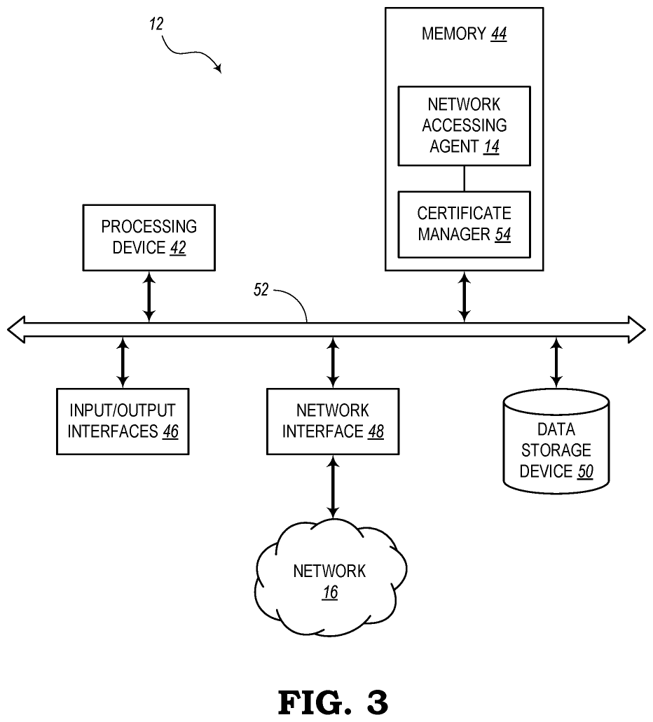

FIG. 3 is a block diagram illustrating an embodiment of one of more of the user devices 12 shown in FIG. 1. In this embodiment, the user device 12 is shown in simplified form and is implemented as a computing system (or processing system) having a processing device 42, memory 44, input/output (I/O) interfaces 46, a network interface 48, and a data storage device 50, each interconnected via a local interface 52 (or bus) to enable communication therebetween. The network interface 48 enables the user device 12 to communicate with other devices of the communications system 10 via the network 16. Furthermore, the user device 12 includes the network accessing agent 14 (as shown in FIG. 1) and a certificate manager 54, which may be implemented in software or firmware in a non-transitory computer-readable medium (e.g., the memory 44). For example, the network accessing agent 14, as mentioned above, allows the user device 12 to access the network 16. The certificate manager 54 may be configured, as described in more detail below, to receive and store the issued client certificate for the specific user device 12 and/or store certificate information and/or sync code information with respect to other trusted user devices 12 of known friends and colleagues with whom the user may wish to share data, as needed in a secure peer-to-peer communication environment between the network accessing agent 14 of the specific user device 12 and a trusted remote user device 12.

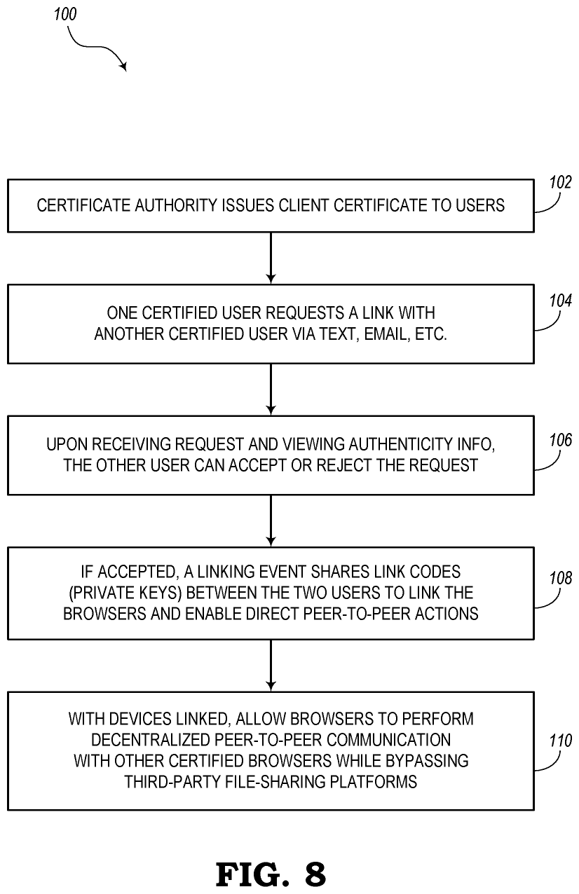

Specifically, the computing systems (i.e., certificate authority 18 shown in FIG. 2 and the user device 12 shown in FIG. 3) may be digital computers that, in terms of hardware architecture, generally includes processing devices 22, 42, memory 24, 44, input/output (I/O) interfaces 26, 46, network interfaces 28, 48, and data storage devices 30, 50. It should be appreciated by those of ordinary skill in the art that FIG. 8 depicts the computing systems in an oversimplified manner, and a practical embodiment may include additional components and suitably configured processing logic to support known or conventional operating features that are not described in detail herein. The components of each computing system are communicatively coupled via local interfaces 32, 52, respectively. The local interfaces 32, 52 may be, for example, but not limited to, one or more buses or other wired or wireless connections, as is known in the art. The local interfaces 32, 52 may have additional elements, which are omitted for simplicity, such as controllers, buffers (caches), drivers, repeaters, and receivers, among many others, to enable communications. Further, the local interfaces 32, 52 may include address, control, and/or data connections to enable appropriate communications among the aforementioned components.

The processing devices 22, 42 are hardware devices for executing software instructions. The processing devices 22, 42 may be any custom made or commercially available processors, Central Processing Units (CPUs), an auxiliary processors among several processors associated with the computing system, semiconductor-based microprocessors (in the form of microchips or chipsets), or generally any devices for executing software instructions. When the computing systems (i.e., certificate authority 18, user device 12) are in operation, the processing devices 22, 42 are configured to execute software stored within the memory 24, 44, to communicate data to and from the memory 24, 44, and to generally control operations of the computing system pursuant to the software instructions. The I/O interfaces 26, 46 may be used to receive user input from and/or for providing system output to one or more devices or components.

The network interfaces 28, 48 may be used to enable the computing system to communicate on a network, such as the Internet or network 16. The network interfaces 28, 48 may include, for example, an Ethernet card or adapter or a Wireless Local Area Network (WLAN) card or adapter. The network interfaces 28, 48 may include address, control, and/or data connections to enable appropriate communications on the network. A data storage devices 30, 50 may be used to store data. The data storage device 30, 50 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data storage devices 30, 50 may incorporate electronic, magnetic, optical, and/or other types of storage media. In one example, the data storage devices 30, 50 may be located internal to the computing system, such as, for example, an internal hard drive connected to the local interfaces 32, 52 in the computing system. Additionally, in another embodiment, the data storage devices 30, 50 may be located external to the computing system such as, for example, an external hard drive connected to the I/O interfaces 26, 46 (e.g., SCSI or USB connection). In a further embodiment, the data storage devices 30, 50 may be connected to the computing system through a network, such as, for example, a network-attached file server.

The memory 24, 44 may include volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 24, 44 may incorporate electronic, magnetic, optical, and/or other types of storage media. Note that the memory 24, 44 may have a distributed architecture, where various components are situated remotely from one another but can be accessed by the processing devices 22, 42. The software in memory 24, 44 may include one or more software programs, each of which includes an ordered listing of executable instructions for implementing logical functions. The software in the memory 24, 44 includes a suitable Operating System (O/S) and one or more programs. The O/S essentially controls the execution of other computer programs, such as the one or more programs, and provides scheduling, input-output control, file and data management, memory management, and communication control and related services. The one or more programs may be configured to implement the various processes, algorithms, methods, techniques, etc. described herein.

In some embodiments, the present disclosure can use Fast Identity Online (FIDO) which is set of technology standards designed to enhance the security of online authentication systems. FIDO standards support a wide range of authentication technologies, including biometrics (such as fingerprint scanners and facial recognition), hardware security keys, and cryptographic security tokens. For example, FIDO can include the client certificate being a hardware token, such as a YubiKey. A YubiKey is a hardware security device designed to provide secure and convenient two-factor authentication (2FA), multi-factor authentication (MFA), and passwordless authentication for a wide range of applications and service. For example, once the YubiKey is plugged in the the user device 12, the browser can access the certificate (user needs to unlock the Yubikey). Now, the browser has securely accessed a valid certificate which will be use to present their identity.

The computing systems further include programs, logic, code, etc. that may be implemented in any suitable combination of hardware (e.g., configured in the processing devices 22, 42) and/or software/firmware (e.g., configured in the memory 24, 44). The programs (e.g., client certificate issuing program 34, network accessing agent 14, certificate manager 54) may be stored in any suitable non-transitory computer-readable media (e.g., the memory 24, 44) and may include computer logic or code having instructions that enable or cause the processing devices 22, 42 to perform certain actions as discussed in the present disclosure.

Of note, the general architecture of the computing systems can define any device described herein. However, the computing systems are merely presented as example architecture for illustration purposes. Other physical embodiments are contemplated, including virtual machines (VM), software containers, appliances, network devices, and the like.

In an embodiment, the various techniques described herein can be implemented via a cloud service. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

### Data Sharing Techniques

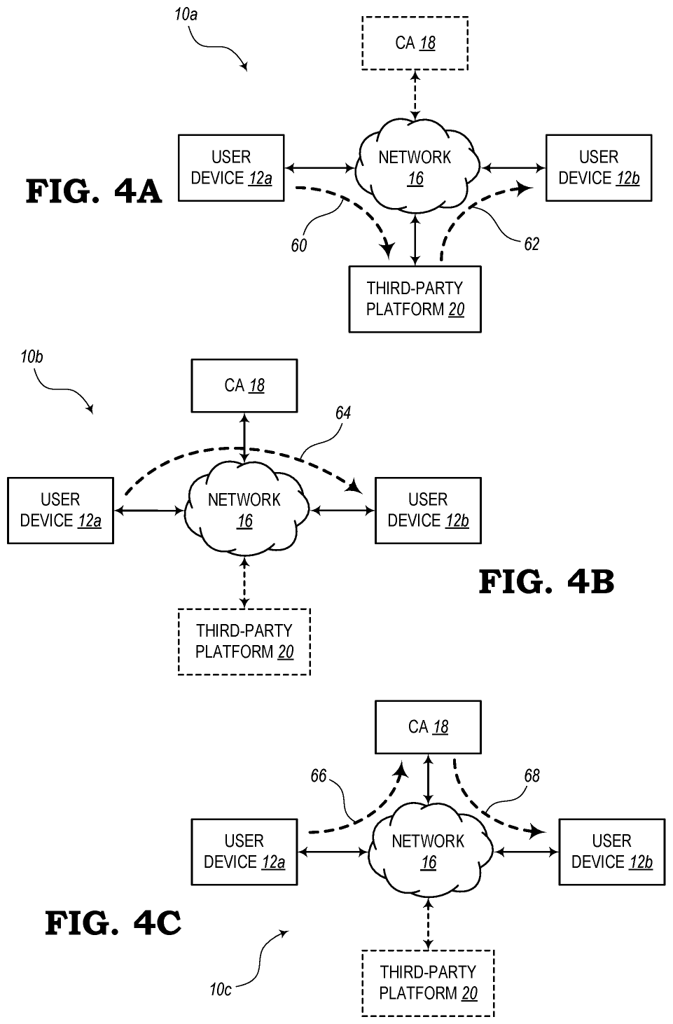

FIGS. 4A-4C are diagrams illustrating different file sharing strategies involving the communications system 10 of FIG. 1. Note, while the term “file” sharing is used herein, those skilled in the art will recognize it can be any digital content, streaming connectivity, etc. It may be noted that the communications system 10 is labelled as 10a in FIG. 4A to depict a first strategy, labelled as 10b in FIG. 4B to depict a second strategy, and labelled as 10c in FIG. 4C to depict a third strategy.

In FIG. 4A, the first strategy may be referred to a traditional file-sharing technique in which a first user device 12 transfers files via a path 60 through the network 16 to the third-party platform 20. For instance, the third-party platform 20 may be configured to store the files, at least temporarily, in a buffer or long-term memory unit. Then, the files are transferred via another path 62 through the network 16 to the other user device 12 to complete the file transfer. One issue with this “centralized” file transfer process is that the security of the files may depend on the capabilities of the third-party platform 20, which may experience hacking attempts and other nefarious actions by untrusted entities. Therefore, the security of the transfer is out of the hands of users and any entities (e.g., certificate authorities 18) that may have a greater interest in file security.

Therefore, according to the systems and methods of the present disclosure, it is possible to avoid the centralized approach and transfer files in a more secure manner. In FIG. 4B, the second strategy includes bypassing the third-party platform 20 altogether via path 64. To secure the file transfer, in accordance with the teachings of the present disclosure, the certificate authority 18 can issue a digital certificate to each of the parties involved in the transfer to ensure that the respective user devices 12 are legitimate. Thus, as shown in FIG. 4B, with the user devices 12 synced together, based on each receiving a “client certificate” from the certificate authority 18, the user devices 12 can transfer files via path 64 in a safer decentralized manner, thereby bypassing the third-party platform 20.

In FIG. 4C, according to one embodiment, a third strategy may be conducted in which files are passed via a first path 66 to the certificate authority 18, which can then check to see if the files are coming from a certified user device 12. If so, the certificate authority 18 can then pass the files along a second path 68 to the other user device 12, again bypassing the less secure third-party platform 20.

### Web Browser Embodiments

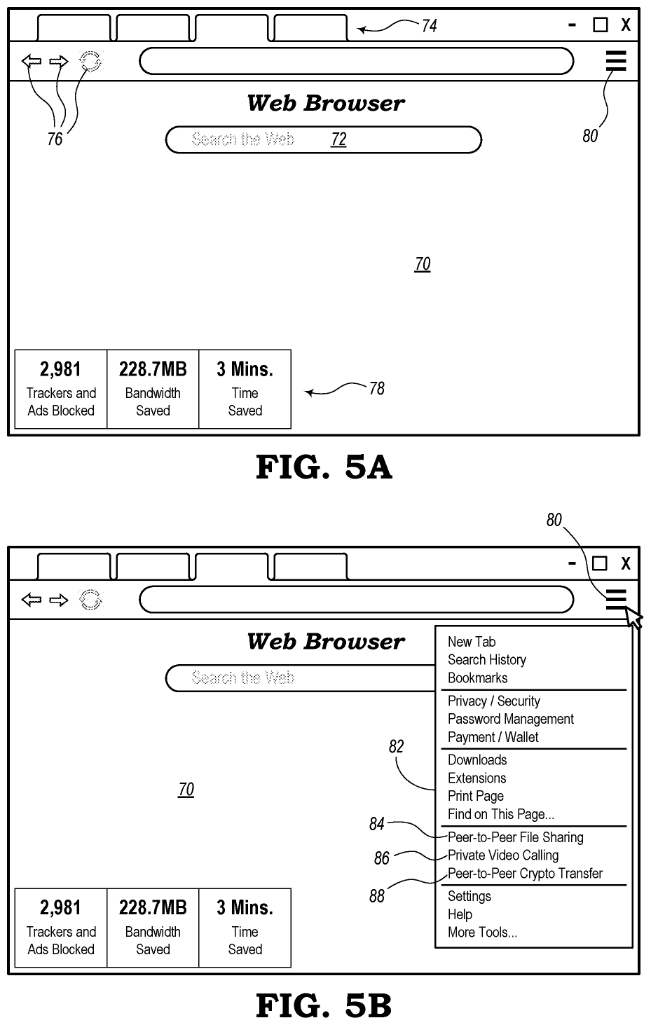

FIG. 5A is a user interface illustrating an embodiment of a web browser 70 that a user (e.g., of the user device 12) may utilize to access the network 16 or access websites, servers, etc. and/or communicate with other devices connected in the communications system 10. As shown, the web browser 70 includes an entry field 72 allowing a user to enter a Uniform Resource Locator (URL), web address, search terms, etc. for browsing the Internet. Also, the web browser 70 is configured to enable the user to have multiple tabs 74 operating in parallel, where the user can select one (or more) of the tabs 74 in which to perform actions with respect to specific pages (e.g., web pages). Furthermore, the web browser 70 may include navigation buttons 76, such as a back button, a forward button, a refresh button, etc. for moving to previous pages, refreshing pages, etc.

In some embodiments, the web browser 70 may have ad blocking capabilities. For example, the web browser 70 may be configured to block trackers, ads, cookies, etc. to enable the user to customize search criteria. In this example, an ad blocking frame 78 displays information about the number of files, trackers, ads, etc. that have been automatically blocked, the amount of bandwidth saved, the amount of time that the user has saved by utilizing the ad blocking feature, and/or other details.

Also, the web browser 70 may include a menu button 80, which is configured to enable a user to see a menu list of certain actions that the web browser 70 can perform. FIG. 5B shows an example of what is displayed on the web browser 70 when the user clicks on the menu button 80.

Thus, in FIG. 5B, when the user clicks on the menu button 80 and/or hovers a mouse pointer over the menu button 80, the web browser 70 is configured to overlay a menu window 82 to show a number of possible options. The menu window 82 may include a list of various search functions and other types of functions that can be executed. As shown in this example, the menu window 82 offers the following selections: a) New Tab, b) Search History, c) Bookmarks, d) Privacy/Security, e) Password Management, f) Payment/Wallet, g) Downloads, h) Extensions, i) Print Page, j) Find on This Page . . . , k) Peer-to-Peer File Sharing, I) Private Video Conference, m) Peer-to-Peer Crypto Transfer, n) Settings, o) Help, and p) More Tools. . . . It should be noted that this list of options is simply an example and may instead include fewer or more items, depending on various implementations, and is not meant to be limited to this exact representation, but can be configured in any suitable manner in accordance with known concepts in the field as well as new concepts discussed in the present disclosure as well as any concepts that may be understood from or suggested by the present disclosure.

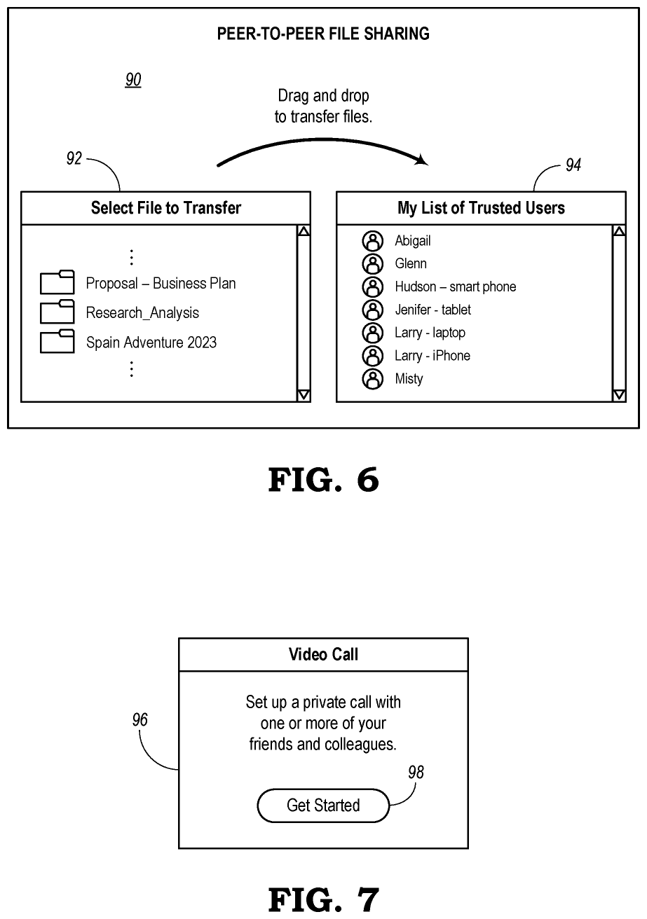

In addition to certain features that may be known in some browsers, the web browser 70 of the present disclosure includes a first novel function pertaining to a Peer-to-Peer File Sharing 84 action, a second novel function pertaining to a Private Video Conference 86 action, and a third novel function pertaining to a Peer-to-Peer Crypto Transfer 88 action. By selecting one of the actions 84, 86, 88, a certified user device 12 is configured to communicate with another certified user device 12 in a peer-to-peer fashion while also bypassing third-party file-sharing platforms (e.g., the third-party file-sharing platform 20). FIGS. 6 and 7, described below, show examples of the web browser 70 when the Peer-to-Peer File Sharing 84 action is selected and when the Private Video Conference 86 action is selected, respectively. The crypto transfer action may be performed in a decentralized way while bypassing online financial institutions, for example.

FIG. 6 is a diagram showing a portion of a user interface representing an embodiment of a file-sharing window 90 that allows a user to perform a decentralized peer-to-peer file sharing action, such as when the Peer-to-Peer File Sharing 84 action of the menu window 82 is mouse clicked or selected in other suitable ways. In this example, the file-sharing window 90 includes a file window 92 showing a list of files that the user may wish to transfer. It may be noted that the file window 92 may organize the files in any suitable manner, listed alphabetically, divided by folders and sub-folders, and other normal file listing strategies. Also, the file-sharing window 90 may include a trusted user window 94 that includes a number of users that have been preapproved and whose devices have been linked or synced with the present user's device.

The linking or syncing actions can be performed, as mentioned below with respect to FIG. 8, to allow trusted devices to communicate directly with each other in a decentralized manner while bypassing third-party platforms. To execute the file transfer, the user may select a file to be transferred from the file window 92 and select a trusted person with whom the file is to be shared from the trusted user window 94. Then, the web browser 70 is configured to automatically transfer the file to the selected user's device. In some cases, the user of the present file-sharing window 90 can use a drag and drop method to visually show the file transfer from the user's device to the other user's device. The file can be dragged and then dropped on the selected user's name or icon.

FIG. 7 is a diagram showing a portion of a user interface representing an embodiment of a video call window 96 allowing a user to set up a decentralized peer-to-peer video call. In this embodiment, the video call window 96 may include instructions for setting up a video call with one other person associated with another trusted user device and/or for setting up a conference call with multiple other people associated with other trusted user devices having the proper client certificate issued by the trusted certificate authority 18. Also, the video call window 96 may include a button 98 for allowing the user to get started with arranging a video call, which may include selected one or more trusted individuals, which may be listed in the same trusted user list in the trusted user window 94 shown in FIG. 6. Also, the user may enter a proposed start time, end time, date, and other details about the call. In some embodiments, the user may use the video call window 96 to join a call, leave a call, etc.

### Peer-to-Peer Communication Processes

FIG. 8 is a flow diagram illustrating an embodiment of a process 100 showing the overall steps for linking two browsers together to enable decentralized peer-to-peer communications. According to the embodiment shown in FIG. 8, the process 100 includes a first step (block 102) where the certificate authority issues client certificates to a number of users, particularly the two users involved in a simple peer-to-peer communication. The process 100 also includes a step in which one of the certified users requests a “link” with another certified user, as indicated in block 104. For example, this request may involve the use of a mobile text message, email, or other suitable mechanisms. Then, upon receiving the request (and viewing the authenticity information associated with the request), the other user can accept or reject the request, as indicated in block 106.

If the request is accepted, the process 100 includes a step of automatically performing a syncing event to share sync codes (e.g., private keys) between the two user devices being linked, as indicated in block 108. Thus, sharing the sync codes is configured to link the browsers (of the two different user devices) together and enables the direct peer-to-peer actions described in the present disclosure. Next, the process 100 includes a step (block 110) of storing the sync codes (in each of the trusted linked devices) to enable the browsers (or network accessing agents 14) to perform decentralized peer-to-peer communications with the other certified browsers in their trusted list, while also bypassing any third-party systems, such as third-party file-sharing platforms.

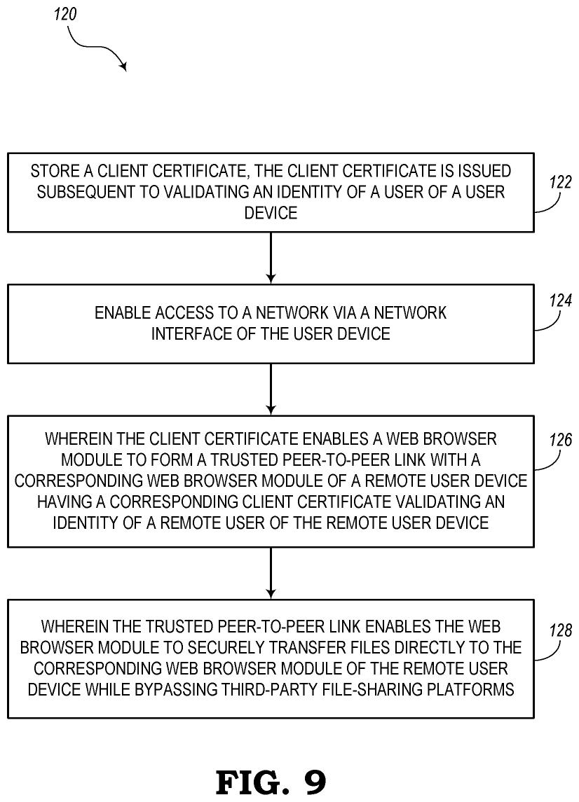

FIG. 9 is a flow diagram illustrating an embodiment of a process 120 for syncing browsers to enable decentralized peer-to-peer communications. In some embodiments, the process 120 may be performed by a processing device (e.g., processing device 42) in association with a web browser module (e.g., network accessing agent 14) or other unit stored in a non-transitory computer-readable medium. The web browser module may include computer logic or code having instructions for enabling or causing the processing device to perform certain actions, such as the actions described with respect to the process 120 of FIG. 9. The process 120 contemplates implementation as a method having steps, via a processing device in a computer or smart device configured to implement the steps, and/or via a non-transitory computer-readable medium storing instructions for programming one or more processors to execute the steps.

As illustrated, the process 120 includes a step of storing a client certificate, as indicated in block 122, wherein the client certificate is issued subsequent to validating an identity of a user of the user device. The process 120 further includes a step of enabling access to a network via a network interface of the user device, as indicated in block 124. As described in block 126, the client certificate enables the web browser module to form a trusted peer-to-peer link with a corresponding web browser module of a remote user device having a corresponding client certificate validating an identity of a remote user of the remote user device. As described in block 128, the trusted peer-to-peer link enables the web browser module to securely transfer data files directly to the corresponding web browser module of the remote user device while bypassing third-party file-sharing platforms.

In some embodiments, each of the network accessing agent and other network accessing agent may either be a web browser or a plug-in for extending the functionality of an existing web browser. In operation, the network accessing agent may be configured to securely transfer data files over the trusted peer-to-peer link according to instructions from the user. The step of securely transferring data files may include securely transmitting web address links, email messages, recorded videos, photos, video call requests, live video during a video call, contact information, and/or map directions. In particular, the transmission of contact information and map directions may be associated with a mobile device where the remote user may need this information.

Also, according to various implementations, the user device may include a certificate manager configured to store the client certificate, whereby the step of forming the trusted peer-to-peer link with the other network accessing agent of the remote user device may include a) sharing link codes associated with the user device with the remote user device, b) receiving other link codes associated with the remote user device from the remote user device, and c) storing the other link codes in the certificate manager. The certificate manager, for example, may be further configured to store link codes and user information associated with a plurality of remote user devices for enabling trusted peer-to-peer links with the plurality of remote user devices.

The network accessing agent, in some embodiments, may include a user interface allowing the user to select a peer-to-peer data sharing action, a private video call set-up action, and/or a peer-to-peer crypto transfer action. For example, regarding the peer-to-peer data sharing action, the user interface may also allow the user to conduct a drag and drop operation to initiate a procedure for transferring files from a file management system of the user device to a remote user device associated with a trusted user selected from a list of trusted users.

The user device, for example, may be a personal computer, a laptop computer, a tablet, or a smartphone. The client certificate and other client certificate are preferably issued by a trusted certificate authority. For instance, the client certificate and other client certificate may be X.509 digital certificates and/or confirm to other digital certification standards and protocols. Also, in some embodiments, the client certificate, which validates the identity of the user of the user device, may also be incorporated into one or more additional user devices to validate that the user is also an owner of the one or more additional user devices.

### Additional Considerations

Thus, the systems and methods of the present disclosure may be configured for issuing and using X.509 digital certificates to craft permission-based data sharing on browsers. It may be noted that conventional browsers can only share data with other browsers via an export function or using common sharing platforms (e.g., third-party file-sharing platforms 20), such as OneDrive, Google Drive, etc. Therefore, the present disclosure provides browsers (and/or plug-ins) having more flexibility to enable them to access valid identities, which may be accepted from the users via their valid certificates. Plug-ins may be applicable for extending known browsers, such as Google Chrome, Microsoft Edge, Apple Safari, Mozilla Firefox, among others. Also, the plug-in may apply to browsers having ad blocking capabilities, such as Brave. The users can then be considered as “trusted users” via the browsers, where they can share links, videos, data files, photos, email messages, and generally any other digital objects, without the need to leave their browser. The systems and methods described herein aim to create a peer-to-peer (P2P) approach to enable users to connect with each other via their browsers.

As is known, most computer users spend a considerable amount of time on their browsers. In recent years, the computing world has seen more and more browser-based applications being developed. For example, Google Docs, Salesforce, and others are browser-based and used for implementing their own applications. One problem, however, is that browser-to-browser communication and browser-to-browser data sharing does not include secure practices where valid identity verification is desired. Therefore, the present disclosure discussed systems and methods for overcoming security issues with browser-to-browser (or P2P) communication.

The P2P connections or links allow data file transfers to friends, family, colleagues, and others who a user may trust and whose identity is known, therefore avoiding the transfer of files and such to unknown people, hackers, or others trying to impersonate someone else. Again, to set-up the P2P link, both parties (known to each other) will normally want to make sure that the link happens when they each know the other person's identity. First, the users can request a client certificate (or other suitable type of digital certificate from a trusted certificate issuing entity, such as the certificate authority 18 (e.g., DigiCert) and both will receive what we will call a “client certificate” (e.g., client certificates 19a, 19b). A client certificate 19 will only be issued when a user can validate his or her identity, such as by showing a picture of himself or herself, providing a copy his or her driver's license, passport, or other identifying documents. From this information, the certificate authority 18 can valid the user's identity and provide the cert. Once the user receives the cert on one device, he or she can import the cert into the browser of that device. Also, the user can link a number of devices together, so that the certificate can be applicable to a number of devices that a user may own, such as a laptop, a tablet, a mobile phone, etc. With the cert added, the user device can reflect that it is owned by the specifically identified user.

Once two or more people in a group (e.g., family, business associates, friends, etc.) have the certs imported in their devices, they can establish a P2P link that will then enable the user to utilize their browsers to send data, files, photos, video, etc. The data transfer may be considered to be similar to a sync procedure, except that, in the present disclosure, the users are identified with certainty, which can prevent a stranger or hacker from tricking the users and intercepting data or information that may be sensitive. With a group of trusted people, each user can set up a list of trusted users. When the list is set up, the user can then safely send data files to friends, family, and colleagues with confidence, even without leaving the browser.

If a user has a valid certificate (e.g., client certificate 19 issued by DigiCert) or private key, the identity of a known individual can be accepted into the user's browser as a trusted user. Once this link is achieved, the user can go ahead and unlock a number of different capabilities. For example, one capability is doing a secure peer-to-peer file transfer. Think about this as having kind of a OneDrive inside the browser that the user grab files and drop them on another username or icon. In one implementation, such a file transfer may be sent to a user, where that user can receive the file transfer on any of their devices. In another implementation, the user may do a file transfer to specific devices. In the example of FIG. 6, a user can drop the file on “Larry—laptop” if they want to send it to the browser on Larry's laptop or they can drop the file on “Larry—iPhone” if they want to send it to the browser on Larry's smartphone. For example, there may be times when certain data may be more applicable to a mobile device, such as contact information (e.g., phone numbers, addresses, etc.) and map directions, where it may be beneficial to allow the sender to make such a distinction.

A benefit of the P2P transfer is that it bypasses any third-party systems, such as the third-party file-sharing platforms 20 (e.g., Microsoft OneDrive, Google Drive, etc.). The data would therefore stay on the users' devices and will not end up in the cloud of a third-party system, where the data is out of the control of the two users involved in the transfer. Removing such intermediaries can avoid the storage of personal data in unknown third-party databases and allow more decentralized operations.

Another advantage of the present systems and methods is that the data remained isolated. When data is dumped in a browser, it can be dumped into one isolated tab of the browser, which remained separated from other tabs. Therefore, the user can open a new tab and perform the P2P action without interference from other activities going on in the other tabs. Each tab has a specific isolated space in memory that can be dedicated to that tab. The user can drop the data in that isolated area, and the system can transmit it to the selected known individual. On their end, the same thing will be achieved. Their browser can open up a new tab and the received files can be contained in that tab opened specifically for that purpose. In the case of a video call (e.g., when Private Video Call 86 is selected), each browser can have an opened tab for that call, within that isolated area.

Some conventional browsers may allow a sync operation. However, it should be noted that a problem with these browsers is that there is no secure way of knowing for sure if a remote user is the person that the user thinks it is. Therefore, by adding identity verification (e.g., using client certificates 19) to the equation, a user can transfer files with certainty knowing that the files are being send to the person that they believe it is. The conventional browser may require a code, but it might be possible for hackers or any unauthorized person to intercept or access that code and proceed with syncing to another person's browser without proper consent.

Referring again to FIG. 7, a video call can be set up ahead of time and then conducted in real time. The window 96 may include any number of instructions, screens, information of current call details, video of one or more other participates in the video call, etc. To set up, one user can arrange a call and send a request to selected users (e.g., using the trusted user list 94).

It may be noted that the client certificate 19 may be used for the P2P file transfer procedure described in the present disclosure. Also, the client certificate 19 may be used for other purposes as well and may be referred to as some other type of certificate that is issued by a trusted entity or certificate authority 18. For example, the client certificate 19 may also be used to certify email addresses and/or sign or certify email messages. Also, the user may choose to send money, funds, assets, crypto, etc. over a secure P2P link and use the client certificate 19 as validation of the user's identity and to verify financial accounts. In some embodiments, the client certificate 19 may have different levels for verifying different activities. For example, for a low-sensitivity data transfer, a low level of certification or security may be needed, while a higher level of transfer (e.g., transferring highly sensitive information or making a monetary transfer) may require a higher level of certification or security.

Also, in some cases, users may wish to use their client certificates 19 for the sake of authenticating to a Wi-Fi network, authenticating to a web server or Secure Shell (SSH), etc. For the sake of signing emails, the user may use what is referred to as Secure/Multipurpose Internet Mail Extensions (S/MIME) or other type of suitable public-key encryption technique. Thus, it may be possible to extend the use of the client certificate 19 for these and other different use cases, such as Wi-Fi authentication, signing an email, etc. Again, the client certificate 19 and other certifications can be issued in accordance with X.509 by the certificate authority 18.

### X.509 Certificate

A certificate authority is an entity that stores, signs, and issues digital certificates. This allows others (relying parties) to rely upon signatures or on assertions made about the private key that corresponds to the certified public key. A CA acts as a trusted third party-trusted both by the subject (owner) of the certificate and by the party relying upon the certificate. For certificate authorities, existing individual validation processes involve the use of third-party verification services to validate basic individual information such as first name, last name, professional title, etc.

X.509 certificates are defined by ITU X.509, Information technology-Open Systems Interconnection-The Directory: Public-key and attribute certificate frameworks, October 2019, the contents of which are incorporated by reference in their entirety. An X.509 certificate binds an identity to a public key using a digital signature. A certificate contains an identity (a hostname, or an organization, or an individual) and a public key (e.g., RSA, DSA, ECDSA, ed25519, etc.), and is signed by a certificate authority. X.509 also defines certificate revocation lists, which are a means to distribute information about certificates that have been deemed invalid by a signing authority, as well as a certification path validation algorithm, which allows for certificates to be signed by intermediate CA certificates, which are, in turn, signed by other certificates, eventually reaching a trust anchor.

When a certificate is signed by a trusted certificate authority, or validated by other means, someone holding that certificate can use the public key it contains to validate documents or content digitally signed by the corresponding private key.

In an embodiment, an X.509 certificate can be used to digitally sign content. A content signing certificate allows individuals, teams and organizations to add an electronic, digital signature to a document or other content in a variety of file formats to prove ownership. The digital signature is an encrypted hash of your message that can only be decrypted by someone who has a copy of your public key, which ensures (1) content stays unaltered, (2) the creator's identity is confirmed, and the like.

A digital signature cryptographically binds a digital signature certificate, issued by a trust services provider (TSP), to a document using public key infrastructure (PKI) technology. Digital signatures validate and authenticate signer identity and document integrity, delivering higher levels of assurance that the signer is who they say they are and that the document hasn't been altered. Digital signatures are ideal for transactions that require higher level of security and are necessary in certain countries and regions where companies are required to comply with legal regulations. In some countries, some forms of digital signatures have legal validity equivalent to handwritten signatures.

In another embodiment, the X.509 certificate can be referred to as a personal certificate, i.e., it does not necessarily need to be used to digitally sign content. In a further embodiment, the X.509 certificate can be a content credential that includes history and identity data attached to content. A user can view this data when a creator or producer has attached it to content to understand more about what has been done to it, where it has been, and who is responsible. Content credentials are public and tamper-evident, and can include info like edits and activity, assets used, identity info, and more.

### Conclusion

It will be appreciated that some embodiments described herein may include one or more generic or specialized processors (“one or more processors”) such as microprocessors; central processing units (CPUs); digital signal processors (DSPs): customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a read-only memory (ROM), a programmable read-only memory (PROM), an erasable programmable read-only memory (EPROM), an electrically erasable programmable read-only memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

What is claimed is:

1. A user device comprising a processor, a network interface, a network accessing agent, and a client certificate stored thereon, the client certificate configured for validating an identity of a user of the user device,
wherein the network accessing agent enables the user device to access a network via the network interface,
wherein the client certificate enables the network accessing agent to form a trusted peer-to-peer link with a corresponding network accessing agent of a remote user device having a corresponding client certificate validating an identity of a remote user of the remote user device, and
wherein the trusted peer-to-peer link enables the network accessing agent to securely transfer data files directly to the corresponding network accessing agent of the remote user device while bypassing third-party file-sharing platforms.

2. The user device of claim 1, wherein each of the network accessing agent and corresponding network accessing agent is either a web browser or a plug-in for extending functionality of an existing web browser.

3. The user device of claim 1, wherein, in operation, the network accessing agent is configured to securely transfer data files over the trusted peer-to-peer link according to instructions from the user.

4. The user device of claim 1, wherein securely transferring data files includes securely transmitting one or more of web address links, email messages, recorded videos, photos, video call requests, live video during a video call, contact information, and map directions.

5. The user device of claim 1, further comprising a certificate manager configured to store the client certificate, wherein forming the trusted peer-to-peer link with the corresponding network accessing agent of the remote user device includes:
sharing link codes associated with the user device with the remote user device,
receiving, from the remote user device, remote link codes associated with the remote user device, and
storing the remote link codes in the certificate manager.

6. The user device of claim 5, wherein the certificate manager is further configured to store link codes and user information associated with a plurality of remote user devices for enabling trusted peer-to-peer links with the plurality of remote user devices.

7. The user device of claim 1, wherein the network accessing agent includes a user interface allowing the user to select one or more of a peer-to-peer data sharing action, a private video call set-up action, and a peer-to-peer crypto transfer action.

8. The user device of claim 7, wherein the user interface allows the user to conduct a drag and drop operation to initiate a procedure for transferring files from a file management system of the user device to a remote user device associated with a trusted user selected from a list of trusted users.

9. The user device of claim 1, wherein the user device is one of a personal computer, a laptop computer, a tablet, and a smartphone.

10. The user device of claim 1, wherein the client certificate and corresponding client certificate are issued by a trusted certificate authority.

11. The user device of claim 10, wherein the client certificate and corresponding client certificate are X.509 digital certificates.

12. The user device of claim 1, wherein the client certificate is also incorporated into one or more additional user devices to validate that the user is also an owner of the one or more additional user devices.

13. A non-transitory computer-readable medium configured to store a web browser module, the web browser module comprising computer logic having instructions that enable one or more processors of a user device to perform steps of:
storing a client certificate, the client certificate is issued subsequent to validating an identity of a user of the user device, and
enabling access to a network via a network interface of the user device,
wherein the client certificate enables the web browser module to form a trusted peer-to-peer link with a corresponding web browser module of a remote user device having a corresponding client certificate validating an identity of a remote user of the remote user device, and
wherein the trusted peer-to-peer link enables the web browser module to securely transfer data files directly to the corresponding web browser module of the remote user device while bypassing third-party file-sharing platforms.

14. The non-transitory computer-readable medium of claim 13, wherein each of the web browser module and corresponding web browser module is either a web browser or a plug-in for the web browser.

15. The non-transitory computer-readable medium of claim 13, wherein the step of storing the client certificate further includes:
receiving the client certificate from a trusted certificate authority, and
storing the client certificate in a certificate manager configured to store user names and link codes associated with a plurality of remote user devices connected to the user device by a plurality of trusted peer-to-peer links,
wherein the client certificate and corresponding client certificates associated with the plurality of remote user devices are X.509 certificates.

16. The non-transitory computer-readable medium of claim 13, wherein the web browser module includes a user interface allowing the user to select a peer-to-peer data sharing action or a private video call set-up action, and wherein the user interface allows the user to conduct a drag and drop operation to initiate a procedure for transferring files from a file management system of the user device to a remote user device associated with a trusted user selected from a list of trusted users.

17. The non-transitory computer-readable medium of claim 13, wherein the user device is one of a personal computer, a laptop computer, a tablet, and a smartphone.

18. A certificate authority comprising:
a processing device, and
memory configured to store computer logic having instructions that enable the processing device to perform steps of:
upon receiving information from a user proving an identity of the user, issuing a client certificate to a user device associated with the user, the client certificate is issued subsequent to validation of the identity of the user, and
supplying a web browser module to the user device, the web browser module configured to enable the user device to:
access a network, and
form a trusted peer-to-peer link with a corresponding web browser module of a remote user device having a corresponding client certificate validating an identity of a remote user of the remote user device,
wherein the trusted peer-to-peer link enables the web browser module to securely transfer data files directly to the corresponding web browser module of the remote user device while bypassing third-party file-sharing platforms.

19. The certificate authority of claim 18, wherein each of the web browser module and corresponding web browser module is either a web browser or a plug-in for extending functionality of an existing web browser.

20. The certificate authority of claim 18, wherein the client certificate and corresponding client certificate are X.509 digital certificates.
